(19) United States
(12) Patent Application Publication
(10) Pub. No.: US 2026/0156311 A1
(43) Pub. Date: Jun. 4, 2026

(54) DYNAMIC CONTENT DELIVERY NETWORK SWITCHING METHOD

(71) Applicant: Wise Point Solutions Technology Ltd., Taipei City (TW)

(72) Inventor: CHENG HUNG YAO, Taipei City (TW)

(21) Appl. No.: 19/120,216

(22) PCT Filed: May 23, 2023
(86) PCT No.: PCT/CN2023/095764

§ 371 Date: Feb. 10, 2026

(51) Int. Cl. H04N 21/24; H04N 21/231; H04N 21/658; H04N 21/8543; H04N 21/858

(52) U.S. Cl. CPC H04N 21/2407; H04N 21/23106; H04N 21/658; H04N 21/8543; H04N 21/8586

(57) ABSTRACT

A dynamic content delivery network switching method (CDN) is disclosed. The present invention uses a third-party monitoring server to dynamically obtain the data transmission speed of the CDNs node that assist a main server in providing content services through a script code constructed in the homepage content of the content data, and judges accordingly within an adjustment period which CDN node performs poorly, so that each user terminal can be notified to adjust the connected CDN node within a next adjustment period. In this way, the present invention can dynamically and effectively control the connection between the CDN nodes and the user terminals, and increase the sending speed of the content service provided by the main server.

### BACKGROUND OF THE INVENTION

### 1. Technical Field

The present invention is related to a method for selecting the most advantageous Content Delivery Network (CDN), and in particular, to a method for dynamically switching CDN.

### 2. Description of Related Art

CDN refers to an architecture for organizing edge location servers distributed at different geographic locations to achieve collaborative work in order to provide fast delivery of internet content. Since the physical distance between the main server providing the content information and the client terminal may not be shorter than these edge locations, as the physical distance between the two becomes longer, the information transmission time between the two is also longer, and the probability of encountering damage of network infrastructure or signal transmission latency also increases. When the transmission time is shortened, it means faster service can be achieved. Accordingly, the use of CDN edge location server to cache the content information provided by the main server in order to support the nearby client terminal requests is the basic principle for the CDN to provide fast and high-quality content transmission for main server operators. In this information competitive era emphasizing the network traffic, for all content providers, social platform service providers and even instant message service providers, to increase the customer satisfaction, there is a rigid demand for using the CDN to perform information transmission.

In practice, since there is more than one operator capable of providing the main server CDN service, the control capability of CDN operators on the response speed of specific region (such as nation) varies from one another due to the difference in the construction of infrastructure. In addition, for CDN operators with excellent regional service quality may not be able to maintain their quality service due to sudden increase of client terminal requests at the same time, resulting in that the service quality of these quality CDN operators may be inferior to other CDN operators of lower quality during certain period of time. Nevertheless, the main server operator cannot control the performance of its cooperating CDN operators, which leads to a potential risk: if the requests of client terminals cannot be obtained and timely responded via the currently existing CDN, the users will lose faith on the service provided by the main service operator, and they may then switch to use the service of other competitive main server operators, resulting in irreparable business loss.

In general, main server operators also understand the aforementioned risk, such that in terms of their business operation, they tend to sign contracts with several CDN operators at the same time in order to dynamically adjust the CDN used for each region and period based on their past experience. However, such operational adjustment is made based on the historical parameters or even the subjective opinion of the network administrator. In other words, the question on whether the CDN presently selected is able to achieve the maximum outcome for the service provided by the main server has no data basis for verification. To overcome such drawback, the present invention provides a method for dynamically switching CDN.

### BRIEF SUMMARY OF THE INVENTION

This section provides a summary on the main features of the present invention. Other features of the present invention are described in the subsequent paragraphs and sections in detail. The purpose is to include and cover various modifications and similar arrangements of the features and scope of the claims enclosed.

To overcome the aforementioned drawback, the present invention provides a method for dynamically switching CDN. The method comprises: a) adding a scrip code to a homepage content in a content data of an origin domain provided by a main server, and caching a partial content data for saving in a plurality of content delivery network (CDN) nodes in an area, and each one of the CDN nodes generating a specific CDN address for the partial content data respectively; b) the main server providing the homepage content to a plurality of user terminals connected to the domain, and designating one of the CDN nodes to provide the partial content data; c) running the script code on a browser of each one of the user terminals in order to execute the following operations: maintaining connection to a monitoring server; computing a time difference between sending a connection request and receiving the partial content data, and a time difference fed back during subsequent browsing of other parts of the partial content data; and continuously and timely sending any one of the time differences obtained and the CDN address of the CDN node connected to the monitoring server via the user terminal; and d) the monitoring server receiving data sent by the user terminals and executing the following operations cyclically; classifying each one of the user terminals based on the CDN address sent, and updating a time difference sent for each one of the user terminals in each class, and performing a percentile ranking dynamically; computing an average value of the time differences most recently sent by all of the user terminals in each class within an adjustment period, and performing an optimization ranking on the CDN nodes according to the average value of the corresponding CDN address in an ascending order; and when the adjustment period ends, informing all of the user terminals in a class having the average value lower than a minimum setting value to switch the CDN node connected to a best of the optimization ranking, or informing all of the user terminals in any one of the classes having the percentile ranking of the time difference lower than a threshold percentile value to switch the CDN node connected to a best of the optimization ranking.

To overcome the aforementioned drawback, the present invention further provides another method for dynamically switching CDN. The method comprises: a) adding a scrip code to a homepage content in a content data of an origin domain provided by a main server, and caching a partial content data for saving in a plurality of CDN nodes in an area, and each one of the CDN nodes generating a specific CDN address for the partial content data respectively; b) the main server providing the homepage content to a plurality of user terminals connected to the domain, and designating one of the CDN nodes to provide the partial content data; c) running the script code on a browser of each one of the user terminals in order to execute the following operations: maintaining connection to a monitoring server; continuously obtaining a download traffic containing a stream information in the partial content data; and periodically sending the download traffic obtained and the CDN address of the CDN node connected to the monitoring server via the user terminal; and d) the monitoring server receiving data sent by the user terminals and executing the following operations cyclically; classifying each one of the user terminals based on the CDN address sent, and updating a download traffic most recently sent for each one of the user terminals in each class, and performing a percentile ranking dynamically; computing an average value of the download traffic most recently sent by all of the user terminals in each class within an adjustment period, and performing an optimization ranking on the CDN nodes according to the average value of the corresponding CDN address in a descending order; and when the adjustment period ends, informing all of the user terminals in a class having the average value lower than a minimum setting value to switch the CDN node connected to a best of the optimization ranking, or informing all of the user terminals in any one of the classes having the percentile ranking of the download traffic lower than a threshold percentile value to switch the CDN node connected to a best of the optimization ranking.

To overcome the aforementioned drawback, the present invention further provides still another method for dynamically switching CDN. The method comprises: a) adding a scrip code to a homepage content in a content data of an origin domain provided by a main server, and caching a partial content data for saving in a plurality of CDN nodes in an area, and each one of the CDN nodes generating a specific CDN address for the partial content data respectively; wherein a weight value is set for each one of the CDN nodes; b) the main server providing the homepage content to a plurality of user terminals connected to the domain, and designating one of the CDN nodes to provide the partial content data; c) running the script code on a browser of each one of the user terminals in order to execute the following operations: maintaining connection to a monitoring server; computing a time difference between sending a connection request and receiving the partial content data, and a time difference fed back during subsequent browsing of other parts of the partial content data; and continuously and timely sending any one of the time differences obtained and the CDN address of the CDN node connected to the monitoring server via the user terminal; and d) the monitoring server receiving data sent by the user terminals and executing the following operations cyclically; classifying each one of the user terminals based on the CDN address sent, and updating a time difference sent for each one of the user terminals in each class, and performing a percentile ranking dynamically; computing an average value of the time differences most recently sent by all of the user terminals in each class within an adjustment period; and when the adjustment period ends, informing all of the user terminals in a class having the average value lower than a minimum setting value to switch the CDN node connected to another of the CDN nodes having a largest value of the weight value, or informing all of the user terminals in any one of the classes having the percentile ranking of the time difference lower than a threshold percentile value to switch the CDN node connected to another of the CDN nodes having a largest value of the weight value.

To overcome the aforementioned drawback, the present invention further provides still another method for dynamically switching CDN. The method comprises: a) adding a scrip code to a homepage content in a content data of an origin domain provided by a main server, and caching a partial content data for saving in a plurality of CDN nodes in an area, and each one of the CDN nodes generating a specific CDN address for the partial content data respectively; wherein a weight value is set for each one of the CDN nodes; b) the main server providing the homepage content to a plurality of user terminals connected to the domain, and designating one of the CDN nodes to provide the partial content data; c) running the script code on a browser of each one of the user terminals in order to execute the following operations: maintaining connection to a monitoring server; continuously obtaining a download traffic containing a stream information in the partial content data; and periodically sending the download traffic obtained and the CDN address of the CDN node connected to the monitoring server via the user terminal; and d) the monitoring server receiving data sent by the user terminals and executing the following operations cyclically; classifying each one of the user terminals based on the CDN address sent, and updating a download traffic most recently sent for each one of the user terminals in each class, and performing a percentile ranking dynamically; computing an average value of the download traffic most recently sent by all of the user terminals in each class within an adjustment period; and when the adjustment period ends, informing all of the user terminals in a class having the average value lower than a minimum setting value to switch the CDN node connected to another of the CDN nodes having a largest value of the weight value, or informing all of the user terminals in any one of the classes having the percentile ranking of the download traffic lower than a threshold percentile value to switch the CDN node connected to another of the CDN nodes having a largest value of the weight value.

According to the present invention, in step b), the CDN node providing the partial content data can be a best or a worst of the optimization ranking.

According to the present invention, in step b), the CDN node providing the partial content data can also be a CDN node having a lowest operating cost or a CDN node having a highest operating cost.

According to the present invention, the script code further sends a connection confirmation signal to the monitoring server periodically via the user terminal; if the monitoring server fails to receive the connection confirmation signal after connection and after exceeding an offline delay, the monitoring server then determines that the corresponding user terminal is under an offline state, and the percentile ranking is not performed and the average value is not computed for data sent by the corresponding user terminal to the monitoring server.

According to the present invention, the monitoring server further performs the following operation: statistically analyzing a quantity of the user terminals currently connected to each one of the CDN nodes, and reporting to the main server.

According to the present invention, the script code further performs the following operation: if the CDN node connected fails to provide a response to a request sent, a connection failure message is sent to the monitoring server via the user terminal. In addition, the monitoring server further performs the following operation: computing a failure rate of a quantity of the user terminals sending the connection failure message over a quantity of all of the user terminals in the class within the adjustment period; and when the adjustment period ends, if the failure rate of any one of the classes is higher than a minimum acceptable value, informing all of the user terminals in the class to switch the CDN node connected to the best of the optimization ranking or another of the CDN nodes having a largest value of the weight value.

The present invention uses a third-party monitoring server to dynamically obtain the data transmission speed of the CDN nodes that assist a main server in providing content services through a script code constructed in the homepage content of the content data, and judges accordingly within an adjustment period which CDN node performs poorly, so that each user terminal can be notified to adjust the connected CDN node within a next adjustment period. In this way, the present invention can dynamically and effectively control the connection between the CDN nodes and the user terminals, and increase the sending speed of the content service provided by the main server.

### BRIEF DESCRIPTION OF THE SEVERAL VIEWS OF THE DRAWINGS

FIG. 1 is a flow chart of a method for dynamically switching CDN according to a first embodiment of the present invention;

FIG. 2 shows a hardware architecture applied to the method for dynamically switching CDN;

FIG. 3 is a chart illustrating the CDN address class and time difference sequentially sent by each user terminal within an adjustment period;

FIG. 4 shows the change of the hardware architecture after an adjustment period;

FIG. 5 is a chart illustrating the CDN address class, time difference and connection failure message sequentially sent by each user terminal within the adjustment period;

FIG. 6 is a flow chart of a method for dynamically switching CDN according to a second embodiment of the present invention;

FIG. 7 is a flow chart of a method for dynamically switching CDN according to a third embodiment of the present invention; and

FIG. 8 is a flow chart of a method for dynamically switching CDN according to a fourth embodiment of the present invention.

### DETAILED DESCRIPTION OF THE INVENTION

The present invention is described in detail via the following embodiments.

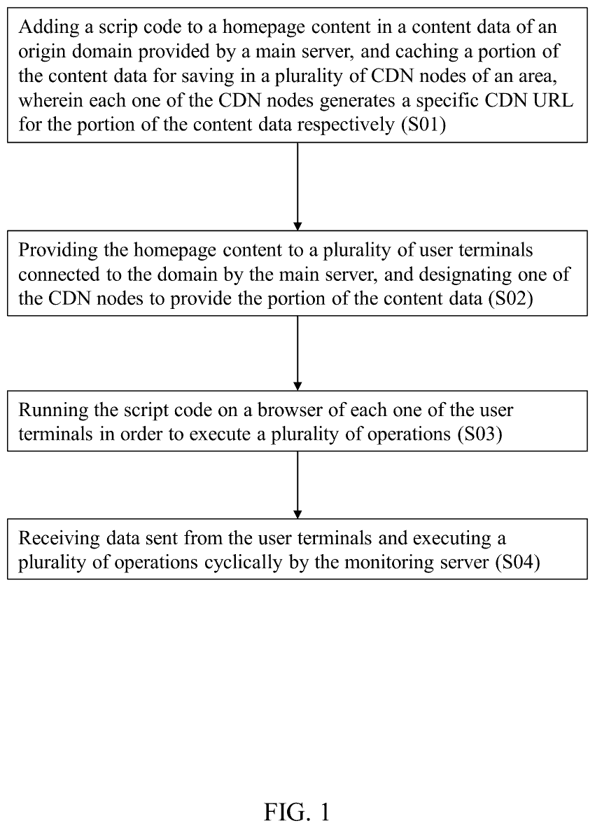

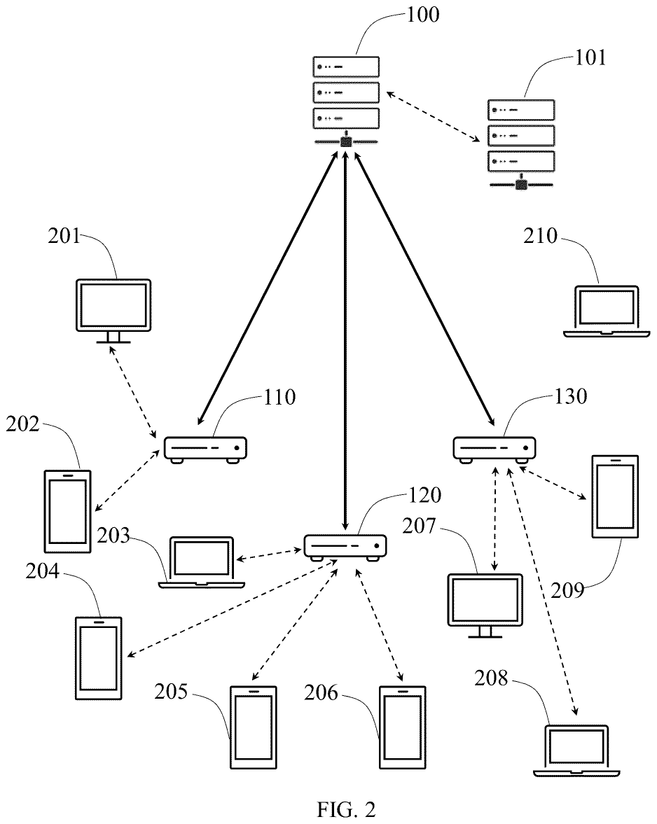

Please refer to FIG. 1 and FIG. 2 FIG. 1 is a flow chart of a method for dynamically switching CDN according to a first embodiment of the present invention. FIG. 2 shows a hardware architecture applied to the method for dynamically switching CDN. The application demand for the method for dynamically switching CDN refers to a certain content service operator (providing static webpage content or dynamic stream data, such as stream video) performs caching of a partial content data corresponding to an origin domain (point to the IP location of the main server) deployed on the main server 100 shown in FIG. 2 for saving in CDN nodes (shown by the bold double-arrow solid line in FIG. 2) of a plurality of CDN service operators in an area. The area described above refers to a geographical territory with a specific crowd gathering such there is a need to provide fast internet content, and such geographical territory may be a country, state, province or region or even an offshore island. Since the physical distance between such area and the location of the main server 100 may be great, when a user terminal (such as smartphone, tablet computer, notebook computer or desktop computer) in the area accesses and obtains content data of the origin domain from the main server 100, the respond time may be too long, or may even encounter access failure. Consequently, the content service operator has the demand to lease the right of use of the CDN nodes from CDN service operators. CDN nodes refer to the servers of CDN service operators. In this embodiment, the situation where three CDN service operators operate the first CDN node 110, the second CDN node 120 and the third CDN node 130 respectively is used as an example for illustration. In practice, the quantity of CDN service operators is at least two and above, such that there is a demand for dynamically switching CDN. Similarly, the quantity of CDN nodes is also at least two nodes.

In this embodiment, the first step of the method for dynamically switching CDN refers to adding a scrip code to a homepage content in a content data of an origin domain provided by a main server 100, and caching a partial content data for saving in a plurality of CDN nodes of an area, and each one of the CDN nodes generating a specific CDN address for the partial content data respectively (S01). In practice, the script code is a set of JaveScript code, and it can be provided by the operator of a monitoring server 101 to the content service operator of the main server 100, in order to allow the content service operator to add the set of JavaScript code in the main content provided, i.e. in the webpage source code that complies with the HTML standard. The main content refers to a portion or all of the content of the first page sent back by the monitoring server 101 after the user terminal is connected to the origin domain. For example, if the content service provided by the main server 100 refers to static news, and the first page includes several lines of text content and several images, then the homepage content may refer to all of the content of the first page, and the content of other sub-pages refers to the partial content data. The homepage content may also merely include the layout structure of the first page, and the texts and images of the first page and other sub-pages may refer to the partial content data described in step S01. The user terminal obtains the homepage content from the main server 100 and any one of the CDN nodes respectively. After the homepage content is browsed, the other content data is provided by the corresponding CDN noes, and the main server 100 performs no action (shown by the thin double-arrow solid line in FIG. 2). Accordingly, to achieve the aforementioned objective, each CDN node generates a specific CDN address for the partial content data respectively, and the CDN address points to the physical IP location of the CDN node where the partial content data is saved.

The second step of the method for dynamically switching CDN refers to the main server 100 providing the homepage content to a plurality of user terminals connected to the domain, and designating one of the CDN nodes to provide the partial content data (S02). Please refer to FIG. 2. To facilitate the explanation, in this embodiment, 10 user terminals, (first user terminal 201, second user terminal 202, third user terminal 203, fourth user terminal 204, fifth user terminal 205, sixth user terminal 206, seventh user terminal 207, eight user terminal 208, ninth user terminal 209 and tenth user terminal 210) are used as an example for illustration. However, the actual quantity in practice may reach several tenths of thousands of user terminals at the same time. Before a certain time point, some of the aforementioned user terminals access the main server 100 and obtain the homepage content including the script code provided by the main server 100 and the partial content data provided by the designated CDN nodes. In this embodiment, the CDN node designated by the first user terminal 201 and the second user terminal 202 refers to the first CDN node 110. The CDN node designated by the third user terminal 203, the fourth user terminal 204, the fifth user terminal 205 and the sixth user terminal 206 refers to the second CDN node 120. The CDN node designated by the seventh user terminal, the eighth user terminal 208 and the ninth user terminal 209 refers to the third CDN node 130. The tenth user terminal 210 accesses the main server 100 after said time point.

In this embodiment, the third step of a method for dynamically switching CDN refers to running the script code on a browser of each one of the user terminals in order to execute several operations (S03). The script code is to operate the user terminal to complete the monitoring operation on the CDN node performance via the browser under the condition where the user is not aware of such operation. The first operation executed by the script code is to maintain connection to the monitoring server 101. Although FIG. 1 does not show the signal connection between the monitoring server 101 and each one of the user terminals with arrow lines, each user terminal in the figure actually maintains uninterrupted connection with the monitoring server 101 when the partial content is obtained from the respective CDN nodes. Such connection can be direct, or it can be made through specific CDN nodes. In addition, after the script code is executed, the time difference between the user terminal sending out the connection request and receiving the partial content data from the corresponding CDN node can be computed. For example, when the first user terminal 201 sends a request for obtaining content data to the main server 100, the main server 100 is able to send the homepage content containing the script code to the first user terminal 201 via the first CDN node 110, and the partial content data in the first CDN node 110 cached is also provided to the first user terminal 201 correspondingly. After the script code is executed, the log data of the browser on the first user terminal 201 can be inquired in order to obtain the time lapsed for the aforementioned entire process, such as 1200 ms, which refers to the time difference. Subsequently, during the execution process of the script code, it also computes the time difference of the feedback from the first user terminal 201 (receiving other parts of the partial content data) when the first user terminal 201 browses other parts of the partial content data, which also refers to the time difference between the first user terminal 201 sending out the data acquisition request and the receipt of the corresponding partial content data. There are more than two types of time differences. According to the present invention, during the execution of the script code, it also continuously and timely sends any one of the time differences obtained and the CDN address of the first CDN node 110 connected to the monitoring server 101 via the first user terminal 201 in order to allow the monitoring server 101 to perform subsequent operation.

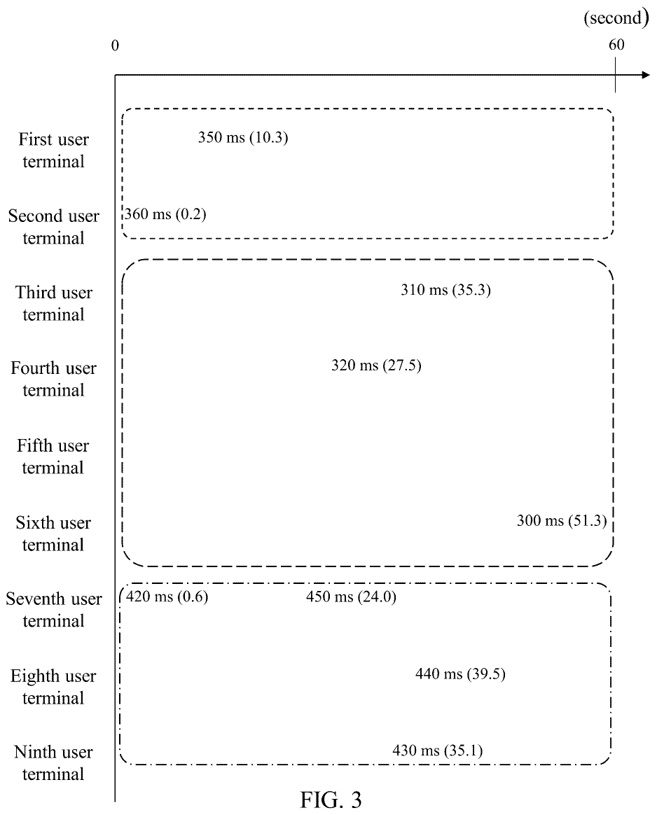

In this embodiment, the fourth step of the method for dynamically switching CDN refers to the monitoring server 101 receiving data sent by the user terminals and executing a plurality of operations cyclically (S04). For the example described in the preceding paragraph, the monitoring server 101 is able to receive the data of the time difference from the first user terminal 201 and the CDN address of the first CDN node 110, and it can also receive the time difference from other user terminals and corresponding CDN address, such as the time difference from the third user terminal 203 and the CDN address of the second CDN node 120, and the time difference from the seventh user terminal 207 and the CDN address of the third CDN node 130. The first user terminal 201 to the ninth user terminal 209 are able to irregularly send out the aforementioned data to the monitoring server 101 to perform analysis. Accordingly, the monitoring server 101 uses an adjustment period as one cycle to cyclically execute a plurality of operations described in the following. First, the monitoring server 101 classifies each one of the user terminals based on the CDN address sent, and updating a time difference sent for each one of the user terminals in each class, and performing a percentile ranking dynamically. Please refer to FIG. 3 for further illustration and better understanding. It shows a chart illustrating the CDN address class and time difference sequentially sent by each user terminal within an adjustment period. According to the present invention, an adjustment period refers to a period of time for the monitoring server 101 to monitor the performance of each CDN node and to adjust the JavaScript CDN node used by each user terminal during the start of next adjustment period, and it can be any appropriate continuous time of 30 seconds, 45 seconds or 60 seconds. The adjustment period shown in FIG. 3 refers to 60 seconds. FIG. 3 illustrates the time difference from each user terminal during said adjustment period, such as the time difference send from the second user terminal 202 is 360 ms. The time received by the monitoring server 101 is listed in the brackets at the rear of the time difference. For example, 360 ms of the second user terminal 202 is received by the monitoring server 101 at the time of 0.2 second from the start of the adjustment period. The first user terminal 201 and the second user terminal 202 transmit the CDN address of the first CDN node 110, such that they are classified as Class 1, and its time difference is indicated inside the short-dashed line brackets. Similarly, the third user terminal 203 to the sixth user terminal 206 transmit the CDN address of the second node 120, such that they are classified as Class 2, and the time difference is indicated inside the long-dashed line brackets. The seventh user terminal 207 to the ninth user terminal 209 transmit the CDN address of the third CDN note 130, such that they are classified as Class 3, and the time difference is indicated in dot-dashed line brackets. In Class 1, the percentile ranking is the first user terminal 201 (50%)→the second user terminal 202 (100%). In Class 2, although the fifth user terminal 205 does not transmit any time difference within said adjustment period, under the condition where the fifth user terminal 205 maintains the connection to the monitoring server 101, its time difference may use the previous closest data, such as 330 ms. Accordingly, the percentile ranking of Class 2 is the sixth user terminal 206(25%)→the third user terminal 203(50%)→the fourth user terminal 204(75%)→the fifth user terminal 205(100%). In Class 3, the seventh user terminal 207 transmits two time differences within said adjustment period; therefore, there are two percentile rankings according to the time sequence for Class 2: the seventh user terminal 207(33%)-the ninth user terminal 209(66%)→the eighth user terminal 208(100%), and the ninth user terminal 209(33%)→the eighth user terminal 208(66%)→the seventh user terminal 207(100%). If subsequent judgment is to be made, the percentile ranking that is closer to the end of the adjustment period will be used.

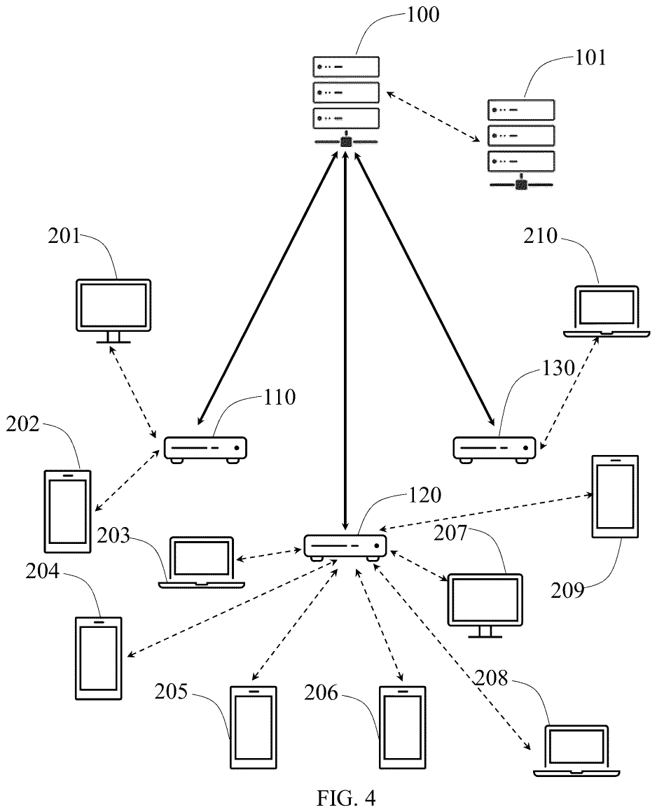

Another operation of the monitoring server 101 refers to computing an average value of the time differences most recently sent by all of the user terminals in each class within an adjustment period, and performing an optimization ranking on the CDN nodes according to the average value of the corresponding CDN address in an ascending order. Please refer to FIG. 3. The average value of Class 1 within the adjustment period is 350 ms, and the average value for Class 2 is 315 ms. The average value of Class 3 uses the last one, and it is 440 ms. Accordingly, the result of optimization ranking refers to the second CDN node 120 (corresponding to Class 2)→the first CDN node 110 (corresponding to Class 1)→the third CDN node 130 (corresponding to Class 3). Another operation of the monitoring server 101 refers to switching the CDN node connected during the end of the adjustment period. According to the present invention, there are two types of switch method: First, when the adjustment period ends, informing all of the user terminals in a class having the average value lower than a minimum setting value to switch the CDN node connected to a best of the optimization ranking; Second, informing all of the user terminals in any one of the classes having the percentile ranking of the time difference lower than a threshold percentile value to switch the CDN node connected to a best of the optimization ranking. For the first type of switch method, if the minimum setting value is 450 ms, and all of the average values are higher than the minimum setting value, then within the next 60 seconds, each user terminal maintains its connection to the CDN node in use without any change. If the minimum setting value is 400 ms, and the average value of the third CDN node 130 is lower than 400 ms, then during the next 60 seconds, the seventh user terminal 207, the eighth user terminal 208 and the ninth user terminal 209 connected to the third CDN node 130 will be informed to change to use the second CDN node 120, as shown in FIG. 4. For the second type of switch method, if the threshold percentage value is set to 80%, since the best of the optimization ranking refers to the second CDN node 120, the second user terminal 202 in Class 1 and the seventh user terminal 207 in Class 3 will be informed to change to use the second CDN node 120 during the next 60 seconds due to their percentile rankings are lower than 80%.

According to the present invention, when a new adjustment period starts, if there is a new user terminal, such as the tenth user terminal 210, for connecting to the main server 100, then the tenth user terminal 210 needs to comply with step S02 of the method for dynamically switching CDN. In step S02, the main server 100 designates the CDN node used for providing the partial content data to be the aforementioned best or worst of the optimization ranking. In this embodiment, it can be the second CDN node 120 or the third CDN node 130. The purpose of selecting the best of the optimization ranking is to allow the tenth user terminal 210 to use the better service of the second CDN node 120, or to allow the tenth user terminal 210 to be used as a “vanguard” in order to test whether the service of the third CDN node 130 resumes to the normal standard during the next 60 seconds. The selection of the best or worst can be set according to the consideration of the main server 100 operator. In addition in step S02, the CDN node used for providing the partial content data and designated by the main server 100 can also be a CDN node having the lowest operating cost or a CDN node having the highest operating cost. The connection to the CDN node of the lowest operating cost may cause the feedback latency to be longer, and the opposite is true for the connection to the CDN node of the highest operating cost. The main server 100 operator can perform setting according to the service agreement of the terminal user. In addition, the purpose of the main server 100 operator using various CDN node services is to optimize its service provided. In other words, the objective is to mitigate the issue of the loss of terminal customers'trust due to information transmission latency as much as possible. Furthermore, the main server 100 operator must know the outcome of each CDN node. Accordingly, the monitoring server 101 is able to further perform the following operation: statistically analyzing a quantity of the user terminals currently connected to each one of the CDN nodes, and reporting to the main server 100. The present invention is not limited to any specific time and frequency of reporting of the monitoring server 101, and they can be set according to the needs of the main server 100 operator.

According to the present invention, the script code can also send a connection confirmation signal to the monitoring server 101 via the user terminal. The connection confirmation signal can be a simple string, and its sending time and frequency are not limited to any specific values; for example, it may be sent once every 30 seconds. After the monitoring server 101 is connected to the user terminal, if the monitoring server fails to receive the connection confirmation signal after connection to the user terminal and after exceeding an offline delay, the monitoring server 101 then determines that the corresponding user terminal is under an offline state. For example, the offline delay can be set to 90 seconds. After a time of 90 seconds has lapsed but no connection confirmation signal is received, then despite that the script code judges that the user terminal is still connected to the monitoring server 101, the monitoring server 101 still judges that the two are disconnected. At this time, the data sent by the corresponding user terminal to the monitoring server 101 is not applicable to the percentile ranking and computation of average value. If the disconnected user terminal is to be re-connected to the monitoring server 101 again, it is necessary to re-connect to the main server 100 and to perform step S02.

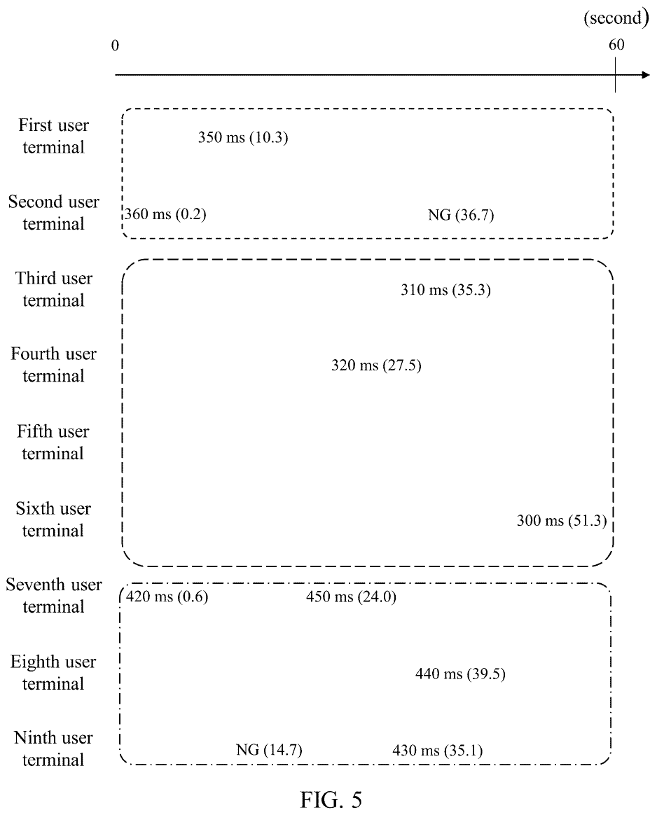

Sometimes the connection between the user terminal and the CDN node may encounter some unexpected problem, such as power outage or insufficient bandwidth, such that the CDN node cannot transmit corresponding data according to the request. To overcome such problem, the script code may perform the following operation: if the CDN node connected fails to provide a response to a request sent, a connection failure message is sent to the monitoring server 101 via the user terminal. The connection failure message can be a simple string, and it is not limited to any type. Please refer to FIG. 5, a figure modified from FIG. 3, and it shows a chart illustrating the CDN address class, time difference and connection failure message sequentially sent by each user terminal within the adjustment period. The connection failure message is indicated as NG, and when the time sequence for the monitoring server 101 receiving the connection failure message is indicated in the brackets at the rear. In FIG. 5, the monitoring server 101 receives the connection failure message sent by the second user terminal 202 at 36.7 seconds, and it receives the connection failure message sent by the ninth user terminal 209 at 14.7 seconds. In response to the above, the monitoring server 101 further performs the following operation: A. computing a failure rate of a quantity of the user terminals sending the connection failure message over a quantity of all of the user terminals in the class within the adjustment period; B. when the adjustment period ends, if the failure rate of any one of the classes is higher than a minimum acceptable value, informing all of the user terminals in the class to switch the CDN node connected to the best of the optimization ranking. In operation A, for the two user terminals of Class 1, since connection failures occur to the second user terminal 202, the failure rate is 50%. For the user terminals of Class 2, since there is no connection failure, the failure rate is 0. For the three user terminals in Class 3, since connection failure occurs to the ninth user terminal 209, the failure rate is 33%. In operation B, the result is determined according to the setting of the minimum acceptable value. If the minimum acceptable value is set to 25%, then all of the three user terminals of Class 3 need to be informed to switch the CDN nodes connected to the best of the optimization ranking before the start of the next adjustment period.

In the aforementioned first embodiment, the main server 100 to which the method for dynamically switching CDN is applied provides static content data, and stream information is excluded. If the content data contains dynamic stream data, such as stream video, then the method for dynamically switching CDN needs to be modified partially. The following uses a second embodiment along with the architecture illustrated in FIG. 3 for further explanation.

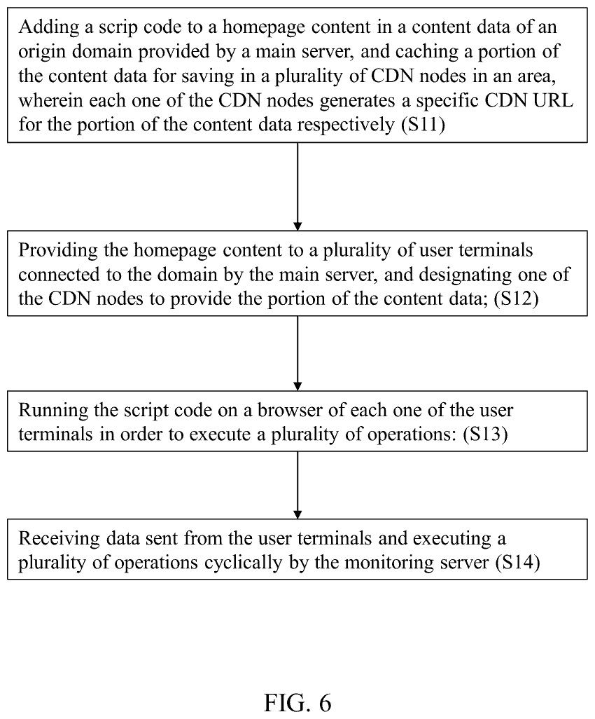

Please refer to FIG. 6, showing a flow chart of a method for dynamically switching CDN according to a second embodiment of the present invention. In this embodiment, the first step (S11) and second step (S12) are substantially the same as the first step (S01) and the second step (S02) in the first embodiment; therefore, details thereof are omitted hereafter.

In this embodiment, the third step of the method for dynamically switching CDN refers to running the script code on a browser of each one of the user terminals in order to execute several operations (S13). Its operation content is different from the third step of the first embodiment. The difference relies in that after the connection to the monitoring server 101 is maintained, the script code continuously obtains the download traffic containing a stream information in the partial content data from the browser, rather than computing a time difference between sending a connection request and receiving the partial content data, and a time difference fed back during subsequent browsing of other parts of the partial content data. The stream video is used as an example for illustration. When the second CDN node 120 provides stream video service to the third user terminal 203, the actual situation is that the second CDN node 120 transmits the data packets of its cached and saved video to the third user terminal 203 sequentially. In terms of the computation, the download traffic can be, such as, how many packets received per second or how may Mbs per second, and such data can be checked and found in the browser record. The service quality (return speed) of the CDN node can be seen and understood from the download traffic. The difference between the two relies in that the script code executes the operation of periodically sending the download traffic obtained and the CDN address of the CDN node connected to the monitoring server 101 via the user terminal. This part can be understood easily in such a way that for the service quality of the CDN node judged by the script code in the transmission data in the first embodiment, the time difference is changed to download traffic. In addition, since the second CDN node 120 continues to provide the data packets of the stream video, the download traffic also needs to be detected and updated for transmission continuously.

In this embodiment, the fourth step of the method for dynamically switching CDN refers to the monitoring server 101 receiving data sent by the user terminals and executing a plurality of operations cyclically (S14). Its operation content is different from the fourth step of the first embodiment. In this embodiment, the monitoring server 101 classifies each one of the user terminals based on the CDN address sent, and updates the download traffic most recently sent for each one of the user terminals in each class, and performs a percentile ranking dynamically. These are similar to the corresponding operations in the first embodiment, but the subject for percentile ranking is the download traffic rather than the time difference. The difference also includes that since the download traffic is updated all the time, the update speed of the percentile ranking becomes very fast. Secondly, the monitoring server 101 is able to compute an average value of the download traffic most recently sent by all of the user terminals in each class within an adjustment period, and performs an optimization ranking on the CDN nodes according to the average value of the corresponding CDN address in a descending order. This operation is also similar to the corresponding operation in the first embodiment. However, since the download traffic data is great, the optimization process can be performed before adjustment period approaches its end time. Finally, when the adjustment period ends, the monitoring server 101 can choose to inform all of the user terminals in a class having the average value lower than a minimum setting value to switch the CDN node connected to the best of the optimization ranking, or to inform all of the user terminals in any one of the classes having the percentile ranking of the download traffic lower than a threshold percentile value to switch the CDN node connected to the best of the optimization ranking. For this operation, the selection of the minimum setting value and threshold percentile value can also be made as previously described; therefore, details thereof are omitted hereafter. In general, for this embodiment, the information of the sequence of download traffic, computation and comparison result is used to inform corresponding user terminals to switch the CDN nodes connected rather than the use of the time difference.

The method of the main server 100 designating the CDN node for providing the partial content data in step S02 described in the first embodiment can be applied to step S12. In addition, the connection confirmation signal and connection failure message interaction method of the script code and monitoring server 101 described in the first embodiment is also applicable to this embodiment. Furthermore, in this embodiment, the monitoring server 101 is able to further statistically analyze a quantity of the user terminals currently connected to each one of the CDN nodes, and report to the main server 100.

When the main server 100 of the method for dynamically switching CDN provides static content, for the time difference being used to determine the performance of the CDN node, it is not necessary to adjust the user terminal having the worst performance of the CDN node connected to the CDN node of the best performance during the next adjustment period, instead, it is able to select the target for switching based on the commercial needs, such as the one with the lower cost of use. The following uses a third embodiment along with the architecture illustrated in FIG. 3 for further explanation.

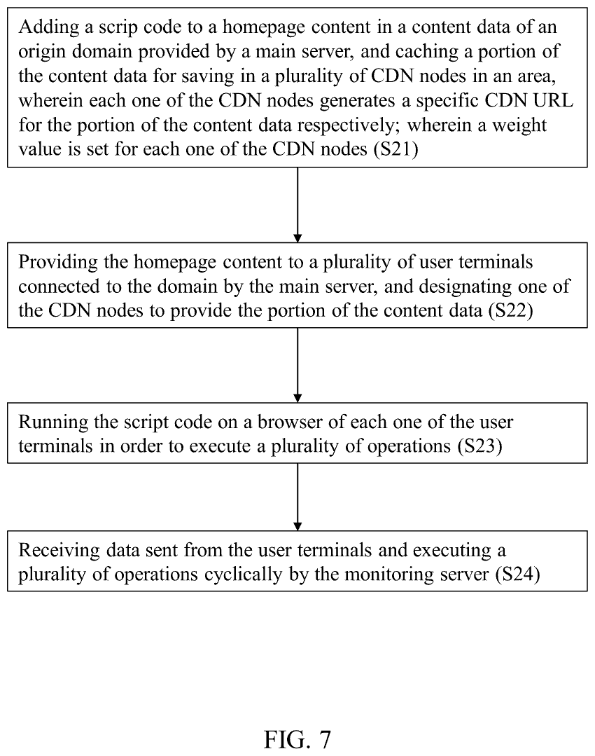

Please refer to FIG. 7, showing a flow chart of a method for dynamically switching CDN according to a third embodiment of the present invention. In this embodiment, the first step of the method for dynamically switching CDN refers to adding a scrip code to a homepage content in a content data of an origin domain provided by a main server 100, and caching a partial content data for saving in a plurality of CDN nodes of an area, and each one of the CDN nodes generating a specific CDN address for the partial content data respectively, wherein a weight value is set for each one of the CDN nodes (S21). In comparison to step S01 of the first embodiment, step S21 in this embodiment further sets a weight value for each CDN node. For example, the weight value of the first CDN node 110 is 1, the weight value of the second CDN node 120 is 2, and the weight value of the third CDN node 130 is 3. The selection of the weight value may be determined based on commercial purposes, such as the aforementioned cost consideration. In addition, for each period, such as hourly, daily and weekly, the weight value of each CDN node can be changed, and this is also a result based on the commercial activity (such as contract terms and conditions).

In this embodiment, the second step (S22) and third step (S23) are substantially the same as the second step (S02) and the third step (S03) in the first embodiment; therefore, details thereof are omitted hereafter.

In this embodiment, the fourth step of the method for dynamically switching CDN refers to the monitoring server 101 receiving data sent by the user terminals and executing a plurality of operations cyclically (S24). Its operation content is different from step S04 of the first embodiment. In this embodiment, the monitoring server 101 classifies each one of the user terminals based on the CDN address sent, and updates the time difference updated and sent for each one of the user terminals in each class, and performs a percentile ranking dynamically. This part of the operation is the same as the first embodiment. However, the difference relies in that the monitoring server 101 computes an average value of the time differences most recently sent by all of the user terminals in each class within an adjustment period only without performing optimization ranking. Accordingly, when the adjustment period ends, the monitoring server 101 informs all of the user terminals in a class having the average value lower than a minimum setting value to switch the CDN node connected to another of the CDN nodes having a largest value of the weight value (third CDN node 130), rather than the best of the optimization ranking. In addition, the monitoring server 101 can also choose to inform all of the user terminals in any one of the classes having the percentile ranking of the time difference lower than a threshold percentile value to switch the CDN node connected to another of the CDN nodes having the largest value of the weight value. In other words, regardless of which user terminal receives the poor CDN node service, its switched CDN node remains the same within a certain period of time.

The method of the main server 100 designating the CDN node for providing the partial content data in step S02 described in the first embodiment, except for the optimization ranking application, can be applied to step S22. In addition, the connection confirmation signal and connection failure message interaction method of the script code and monitoring server 101 described in the first embodiment is also applicable to this embodiment, and the CDN node connected to the user terminal being switched to the best of the optimization ranking is changed to another of the CDN nodes having the largest value of the weight value only. In this embodiment, the monitoring server 101 is able to further statistically analyze a quantity of the user terminals currently connected to each one of the CDN nodes, and report to the main server 100.

When the main server 100 of the method for dynamically switching CDN provides dynamic content, for the downland traffic being used to determine the performance of the CDN node, it is not necessary to adjust the user terminal having the worst performance of the CDN node connected to the CDN node of the best performance during the next adjustment period. The following uses a fourth embodiment for further explanation.

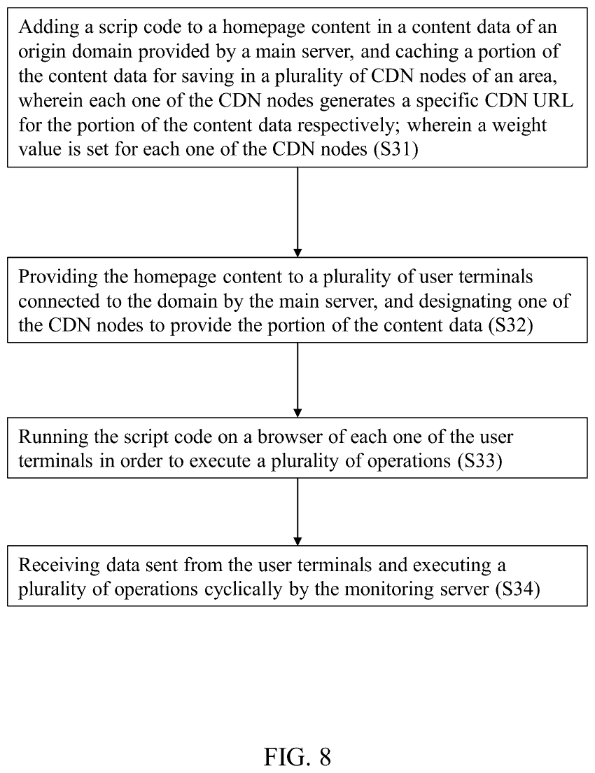

Please refer to FIG. 8, showing a flow chart of a method for dynamically switching CDN according to a fourth embodiment of the present invention. In this embodiment, the first step (S31) and second step (S32) of the method for dynamically switching CDN are the same as the first step (S01) and the second step (S02) in the first embodiment respectively; therefore, details thereof are omitted hereafter.

In this embodiment, the third step of the method for dynamically switching CDN refers to running the script code on a browser of each one of the user terminals in order to execute several operations (S33). Its operation content is different from step S23 of the third embodiment. The difference relies in that after the connection to the monitoring server 101 is maintained, the script code continuously obtains the download traffic containing a stream information in the partial content data from the browser, rather than computing the two types of time differences. The difference between the two relies in that the script code executes the operation of periodically sending the download traffic obtained and the CDN address of the CDN node connected to the monitoring server 101 via the user terminal. Please refer to the second embodiment for detailed description.

In this embodiment, the fourth step of the method for dynamically switching CDN refers to the monitoring server 101 receiving data sent by the user terminals and executing a plurality of operations cyclically (S34). Its operation content is different from step S24 of the third embodiment. In this embodiment, first, the monitoring server 101 classifies each one of the user terminals based on the CDN address sent, and updates the download traffic most recently sent for each one of the user terminals in each class, and performs a percentile ranking dynamically. Next, the monitoring server 101 computes an average value of the download traffic most recently sent by all of the user terminals in each class within an adjustment period. Finally, when the adjustment period ends, the monitoring server 101 can choose to inform all of the user terminals in a class having the average value lower than a minimum setting value to switch the CDN node connected to another of the CDN nodes having the largest value of the weight value, or it can also inform all of the user terminals in any one of the classes having the percentile ranking of the download traffic lower than a threshold percentile value to switch the CDN node connected to another of the CDN nodes having the largest value of the weight value. In this embodiment, the download traffic is used to replace the time difference in the third embodiment, and the weight value is the only factor considered for switching the CDN node connected of the user terminal.

The embodiments of the present invention are provided to illustrate the technical features and effect of the present invention only such that they shall not be used to limit the scope of the present invention. In addition, any person with ordinary skill in the art of any technical field may make any changes and modifications to the present invention without deviating from the principle and scope of the present invention. Accordingly, the scope of protection of the present invention shall be based on the scope of the claims disclosed in the following content.

What is claimed is:

1. A dynamic content delivery network switching method, comprising:
a) adding a scrip code to a homepage content in a content data of an origin domain provided by a main server, and caching a portion of the content data for saving in a plurality of content delivery network (CDN) nodes in an area, wherein each one of the CDN nodes generates a specific CDN URL for the portion of the content data respectively;
b) providing the homepage content to a plurality of user terminals connected to the domain by the main server, and designating one of the CDN nodes to provide the portion of the content data;
c) running the script code on a browser of each one of the user terminals in order to execute the following operations:
maintaining connection to a monitoring server;
computing a time difference between sending a connection request and receiving the portion of the content data, and a time difference fed back during subsequent browsing of other part of the portion of the content data; and
continuously and timely sending any one of the time differences obtained and the CDN URL of the CDN node connected to the monitoring server via the user terminal; and
d) receiving data sent from the user terminals and executing the following operations cyclically by the monitoring server:
classifying each one of the user terminals based on the CDN URL sent, and updating the time difference sent for each one of the user terminals in each class, and performing a percentile ranking dynamically;
computing an average value of the time differences most recently sent from all of the user terminals in each class within an adjustment period, and performing an optimization ranking on the CDN nodes according to the average value of the corresponding CDN URL in an ascending order; and
when the adjustment period ends, informing all of the user terminals in a class having the average value lower than a minimum setting value to switch the CDN node connected to the best one in the optimization ranking, or informing all of the user terminals in any one of the classes having the percentile ranking of the time difference lower than a threshold percentile value to switch the CDN node connected to the best one in the optimization ranking.

2. A dynamic content delivery network switching method, comprising:
a) adding a scrip code to a homepage content in a content data of an origin domain provided by a main server, and caching a portion of the content data for saving in a plurality of CDN nodes in an area, wherein each one of the CDN nodes generates a specific CDN URL for the portion of the content data respectively;
b) providing the homepage content to a plurality of user terminals connected to the domain by the main server, and designating one of the CDN nodes to provide the the portion of the content data;
c) running the script code on a browser of each one of the user terminals in order to execute the following operations:
maintaining connection to a monitoring server;
continuously obtaining a download traffic of a stream information contained in the portion of the content data; and
periodically sending the download traffic obtained and the CDN URL of the CDN node connected to the monitoring server via the user terminal; and
d) receiving data sent from the user terminals and executing the following operations cyclically by the monitoring server:
classifying each one of the user terminals based on the CDN URL sent, and updating the download traffic most recently sent for each one of the user terminals in each class, and performing a percentile ranking dynamically;
computing an average value of the download traffics most recently sent from all of the user terminals in each class within an adjustment period, and performing an optimization ranking on the CDN nodes according to the average value of the corresponding CDN URL in a descending order; and
when the adjustment period ends, informing all of the user terminals in a class having the average value lower than a minimum setting value to switch the CDN node connected to the best one in the optimization ranking, or informing all of the user terminals in any one of the classes having the percentile ranking of the download traffic lower than a threshold percentile value to switch the CDN node connected to the best one in the optimization ranking.

3. A dynamic content delivery network switching method, comprising:
a) adding a scrip code to a homepage content in a content data of an origin domain provided by a main server, and caching a portion of the content data for saving in a plurality of CDN nodes in an area, wherein each one of the CDN nodes generates a specific CDN URL for the portion of the content data respectively and a weight value is set for each one of the CDN nodes;
b) providing the homepage content to a plurality of user terminals connected to the domain by the main server, and designating one of the CDN nodes to provide the portion of the content data;
c) running the script code on a browser of each one of the user terminals in order to execute the following operations:
maintaining connection to a monitoring server;
computing a time difference between sending a connection request and receiving the portion of the content data, and a time difference fed back during subsequent browsing of other parts of the portion of the content data; and
continuously and timely sending any one of the time differences obtained and the CDN URL of the CDN node connected to the monitoring server via the user terminal; and
d) receiving data sent from the user terminals and executing the following operations cyclically by the monitoring server:
classifying each one of the user terminals based on the CDN URL sent, and updating the time difference sent for each one of the user terminals in each class, and performing a percentile ranking dynamically;
computing an average value of the time differences most recently sent from all of the user terminals in each class within an adjustment period; and
when the adjustment period ends, informing all of the user terminals in a class having the average value lower than a minimum setting value to switch the CDN node connected to another of the CDN nodes having a largest value of the weight values, or informing all of the user terminals in any one of the classes having the percentile ranking of the time difference lower than a threshold percentile value to switch the CDN node connected to another of the CDN nodes having a largest value of the weight values.

4. A dynamic content delivery network switching method, comprising:
a) adding a scrip code to a homepage content in a content data of an origin domain provided by a main server, and caching a portion of the content data for saving in a plurality of CDN nodes of an area, wherein each one of the CDN nodes generates a specific CDN address for the portion of the content data respectively and a weight value is set for each one of the CDN nodes;
b) providing the homepage content to a plurality of user terminals connected to the domain by the main server, and designating one of the CDN nodes to provide the portion of the content data;
c) running the script code on a browser of each one of the user terminals in order to execute the following operations:
maintaining connection to a monitoring server;
continuously obtaining a download traffic of a stream information contained in the portion of the content data; and
periodically sending the download traffic obtained and the CDN URL of the CDN node connected to the monitoring server via the user terminal; and
d) receiving data sent from the user terminals and executing the following operations cyclically by the monitoring server:
classifying each one of the user terminals based on the CDN URL sent, and updating the download traffic most recently sent for each one of the user terminals in each class, and performing a percentile ranking dynamically;
computing an average value of the download traffics most recently sent from all of the user terminals in each class within an adjustment period; and
when the adjustment period ends, informing all of the user terminals in a class having the average value lower than a minimum setting value to switch the CDN node connected to another of the CDN nodes having a largest value of the weight values, or informing all of the user terminals in any one of the classes having the percentile ranking of the download traffic lower than a threshold percentile value to switch the CDN node connected to another of the CDN nodes having a largest value of the weight values.

5. The dynamic content delivery network switching method according to claim 1 or 2, wherein in step b), the CDN node providing the portion of the content data refers to a best or a worst of the optimization ranking.

6. The dynamic content delivery network switching method according to any one of claims 1 to 4, wherein in step b), the CDN node providing the portion of the content data refers to a CDN node having a lowest operating cost or a CDN node having a highest operating cost.

7. The dynamic content delivery network switching method according to any one of claims 1 to 4, wherein the script code further sends a connection confirmation signal to the monitoring server periodically via the user terminal; if the monitoring server after connection fails to receive the connection confirmation signal exceeding an offline delay, the monitoring server then determines that the corresponding user terminal is under an offline state, and the percentile ranking is not performed and the average value is not computed for data sent from the corresponding user terminal to the monitoring server.

8. The dynamic content delivery network switching method according to any one of claims 1 to 4, wherein the monitoring server further performs the following operation: computing a number of the user terminals currently connected to each one of the CDN nodes, and reporting the number to the main server.

9. The dynamic content delivery network switching method according to any one of claims 1 to 4, wherein the script code further performs the following operation:
if the CDN node connected fails to provide a response to a request sent, a connection failure message is sent to the monitoring server via the user terminal.

10. The dynamic content delivery network switching method according to claim 9, wherein the monitoring server further performs the following operations:
computing a failure rate of a quantity of the user terminals sending the connection failure message over a quantity of all of the user terminals in a class within the adjustment period; and
when the adjustment period ends, if the failure rate of any one of the classes is higher than a minimum acceptable value, informing all of the user terminals in the class to switch the CDN node connected to the best of the optimization ranking or another of the CDN nodes having the largest value of the weight values.
